(19) United States
(12) Patent Application Publication
(10) Pub. No.: US 2021/0204735 A1
(43) Pub. Date: Jul. 8, 2021

(54) DECORATIVE HOLDER FOR SERVING/CATERING TRAYS AND TINS

(71) Applicant: Sugar Beets, LLC, Agoura Hills, CA (US)

(72) Inventors: Jane Casey, Agoura Hills, CA (US); Charlene Yeager, Chatsworth, CA (US)

(73) Assignee: Sugar Beets, LLC, Agoura Hills, CA (US)

(21) Appl. No.: 17/212,739

(22) Filed: Mar. 25, 2021

Related U.S. Application Data
(63) Continuation of application No. 15/054,564, filed on Feb. 26, 2016, now abandoned.
(60) Provisional application No. 62/259,199, filed on Nov. 24, 2015.
(60) Provisional application No. 62/121,598, filed on Feb. 27, 2015.

(51) Int. Cl. A47G 23/06; A47J 36/10; A47J 47/14; A47G 19/08

(52) U.S. Cl. CPC A47G 23/06; A47G 19/08; A47J 47/14; A47J 36/10

(57) ABSTRACT

A decorative holder for foodstuff trays, tins, and pans, a receptacle has a generally horizontal bottom wall and a contiguous upwardly extending wall, a lid that is hingably coupled to the receptacle, and a cover that is detachably coupled to the lid, the cover having a generally planar upper surface and a peripheral engaging wall that extends generally orthogonally from the upper surface. The lid has a peripheral wall defining a central opening providing access to an interior region of the decorative holder when disposed atop the receptacle, and the peripheral wall of the lid and the peripheral engaging wall of the cover are generally parallel and configured to engage each other when the cover is coupled to the lid. The receptacle and the lid are configured to hold and generally encapsulate a foodstuff tray, tin, or pan therebetween.

### CROSS-REFERENCE TO RELATED APPLICATIONS

This application is a continuation of U.S. patent application Ser. No. 15/054,564, filed Feb. 26, 2016, which claims priority to U.S. Provisional Application Ser. No. 62/121,598 filed Feb. 27, 2015 and U.S. Provisional Application Ser. No. 62/259,199 filed Nov. 24, 2015.

### FIELD OF INVENTION

The present invention relates generally to the field of baking/serving containers. More specifically, the present invention relates to decorative and protective holders for cookware and serving or catering tins and trays.

### BACKGROUND OF THE INVENTION

Foil pans can be very convenient for cooking and preparing various types of food. However, while functional, foil pans are typically not decorative in nature and can detract from a table setting if food is served from the foil pan. Additionally, foil pans are generally flimsy and difficult to carry once food has been prepared in the foil pan.

In some instances, people choose to use ornamental baking or serving dishes instead of foil pans. While ornamental baking or serving dishes do provide for a better presentation, cleanup is typically more difficult.

Additionally, some choose to use foil pans if there is a possibility that leftover food will remain after a meal or gathering, because it is more convenient to leave a foil pan at the meal or gathering than a typical baking or serving dish.

One of the biggest issues with bringing a food dish to a party or event is not wanting to leave precious and expensive cookware or serving dishes where there is a chance that they may never returned. One also runs the risk of having nice containers breaking in transit, or not having the means to wash, rinse or clean the cookware or serving dish when the food that was contained in it is finished.

Accordingly, there is a need for a decorative holder for serving/catering trays and tins which allows the chef, cook or food preparer to safely transport and serve the food in a container without subjecting guests or partygoers to unsightly foil trays. Such a decorative holder should allow for leftovers to be left in the original container while not having to transfer them from your take-home dish to another dish.

The present invention fulfills these needs and provides other related advantages.

### SUMMARY OF THE INVENTION

A decorative holder for serving/catering trays and tins comprises a receptacle for a foil serving tray, the receptacle including a generally horizontal bottom surface and a contiguous upwardly extending wall terminating in a generally horizontal lip. A non-skid surface is provided on at least a portion of an exterior bottom surface of the receptacle. A lid is pivotally attachable by at least one hinge to the lip of the receptacle. The hinge permits the lid to be pivoted between an open position and a closed position where the lid overlies and engages the lip. A snap clamp is provided generally opposite the hinge, for releasably securing the lid to the receptacle when the lid is in the closed position. The receptacle and lid are configured to securely hold and generally encapsulate a serving tray or tin therebetween. The lip of the receptacle and the lid preferably cooperatively sandwich a rim of the serving tray or tin therebetween when the lid is closed.

A cover is provided which is attachable to the lid by engaging a peripheral surface of a central aperture of the lid. An exterior bottom surface of a first receptacle is configured to engage the lid or the cover of an underlying second decorative holder to permit vertical stacking of a plurality of decorative holders while inhibiting horizontal relative movement therebetween.

An optional spacer block is also provided which may be disposed within the receptacle to accommodate shallow foil serving trays or tins. The optional spacer block is preferably insulative.

Other features and advantage of the present invention will become apparent from the following more detailed description, taken in conjunction with the accompanying drawings which illustrate, by way of example the principles of the invention.

### BRIEF DESCRIPTION OF THE DRAWINGS

The accompanying drawings illustrate the invention. In such drawings:

FIG. 1 is an exploded perspective view of a first embodiment of the decorative holder for serving/catering trays and tins, illustrating use of a removable spacer block;

FIG. 2 is an exploded perspective view similar to FIG. 1, illustrating the decorative holder without the optional spacer block.

FIG. 3 is an exploded perspective view similar to FIG. 2, showing a second embodiment wherein a cover is provided for reception within an aperture defined by the lid;

FIG. 4 is an enlarged sectional view of the assembled decorative holder shown in FIG. 3;

FIG. 5 is an enlarged sectional view taken generally of the area indicated by the line 5 from FIG. 4;

FIG. 6 is a perspective view of a third embodiment of the present invention, wherein the lid is pivotally connected to the bottom holder/receptacle;

FIG. 7 is an enlarged sectional view similar to FIG. 4, of the third embodiment of FIG. 6; and

FIG. 8 is an enlarged sectional view taken generally of the area indicated by line 8 from FIG. 7.

### DERAILED DESCRIPTION OF THE PREFERRED EMBODIMENTS

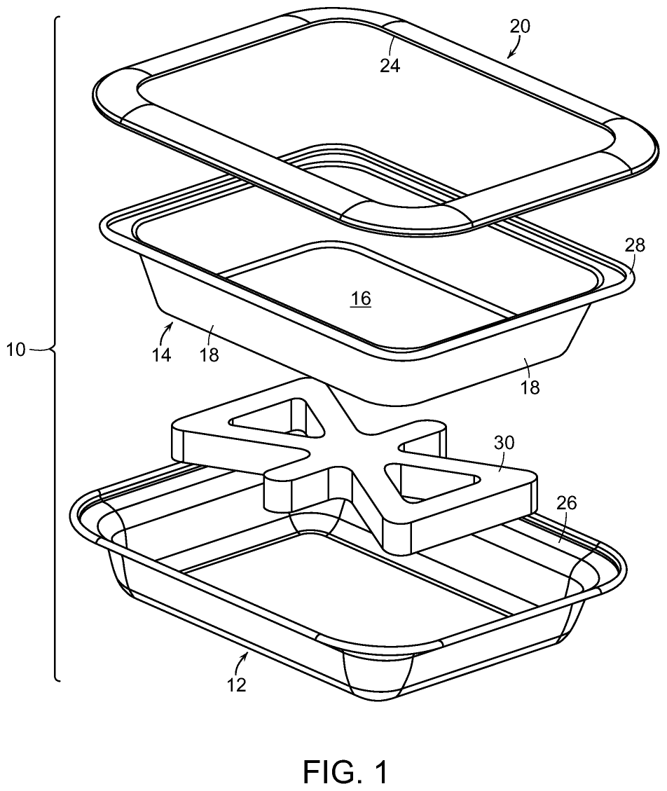

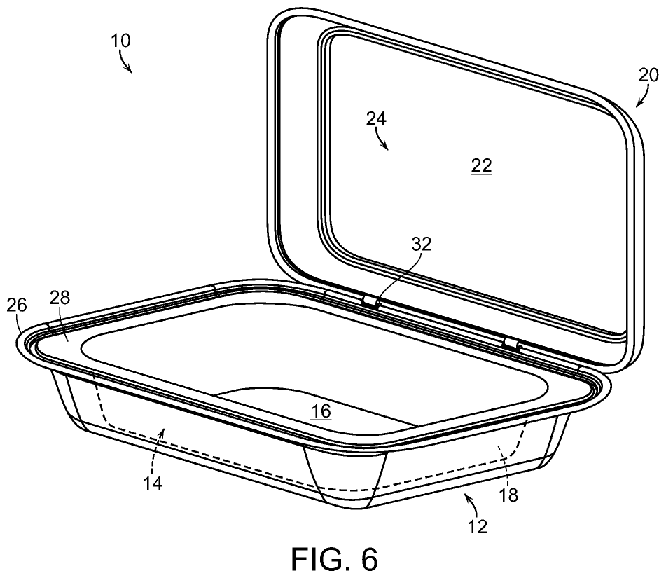

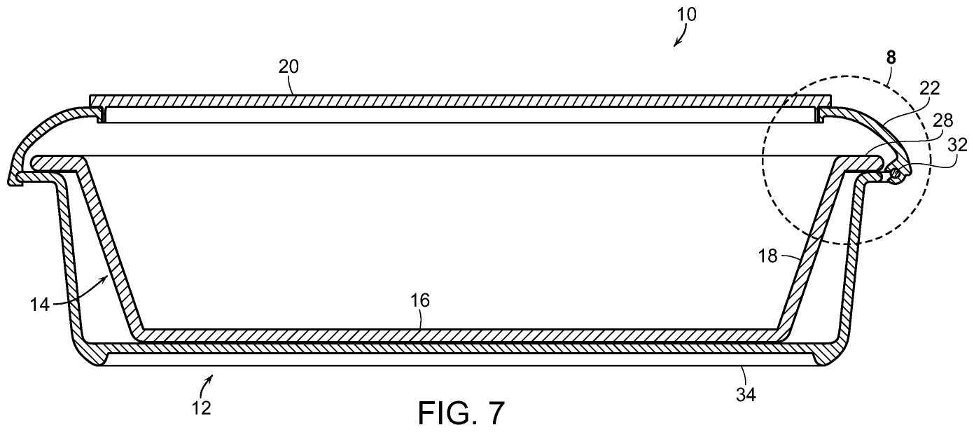

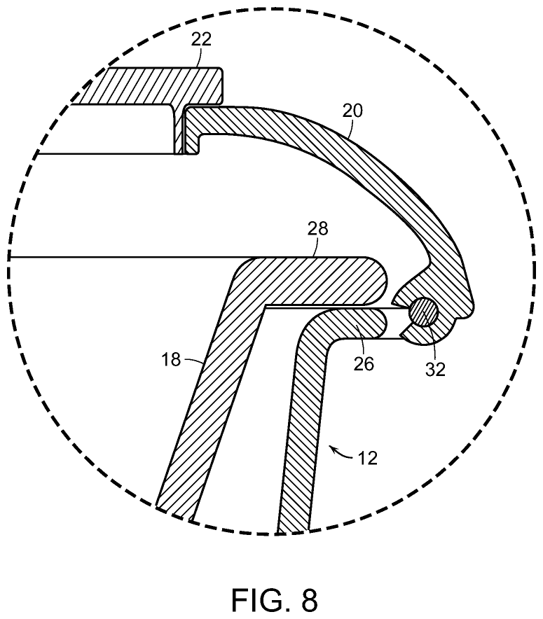

As shown in the drawings for purposes of illustration, a decorative holder 10 for serving/catering trays and tins comprises, generally, a bottom holder/receptacle 12 which receives a traditional serving or catering tin or tray 14, effectively surrounding the bottom 16 and four sides 18 of the tin or tray. A lid 20 is placed over the upper peripheral edges of the holder/receptacle 12 to hold the tin or tray 14 in place and also to cover the upper edges of the serving or catering tin or tray. The lid 20 is preferably snap-fit in place, and may comprise a separable component from the holder/receptacle (FIGS. 1-5), or may be attached along one edge and be pivoted into place over the tin or tray (FIGS. 6-8). Additionally, a cover 22 may be provided which fits within an opening 24 of the lid 20 to completely enclose the catering tin or tray 14 and contents during shipping. The cover 22 also facilitates nested stacking of the decorative holder 10.

FIG. 1 shows an exploded view of one preferred form of the invention. There is a bottom holder/receptacle 12 which accommodates the tray 14 in its entirety. The bottom holder/receptacle 12 also has a lip 26 to help support the rim 28 of the tray 14. The lid 20 is either snapped into place while being fully removable (FIGS. 1-5) or it is hinged on one side (FIGS. 6-8). The purpose of the lid 20 is to both add to the decorative aspect of the holder 10 as well as helping to encapsulate and retain the tray 14 within the bottom holder/receptacle 12 by sandwiching the rim 28 of the tray 14 between the lip 26 and the lid 20.

A spacer block 30 may also be provided that sits inside the bottom holder/receptacle 12 for either accommodating a shallower tray 14 or providing insulation between the serving tray 14 and the bottom holder/receptacle. The optional insulative spacer block 30 is removable.

This decorative holder 10 may be made with various materials, both natural and synthetic, such as metal, ceramic, wood, cardboard, paper, fabric, or a vast array of plastics both food grade or non-food grade. This decorative holder 10 may also be manufactured by metal stamping, machining, molding, carving, injection molding, or vacuum forming (Vacuform). The decorative aspects of the holder 10 can be painted, printed, silkscreened on or molded into the areas that are visually seen including the lid 20 and all sides of the bottom holder/receptacle 12.

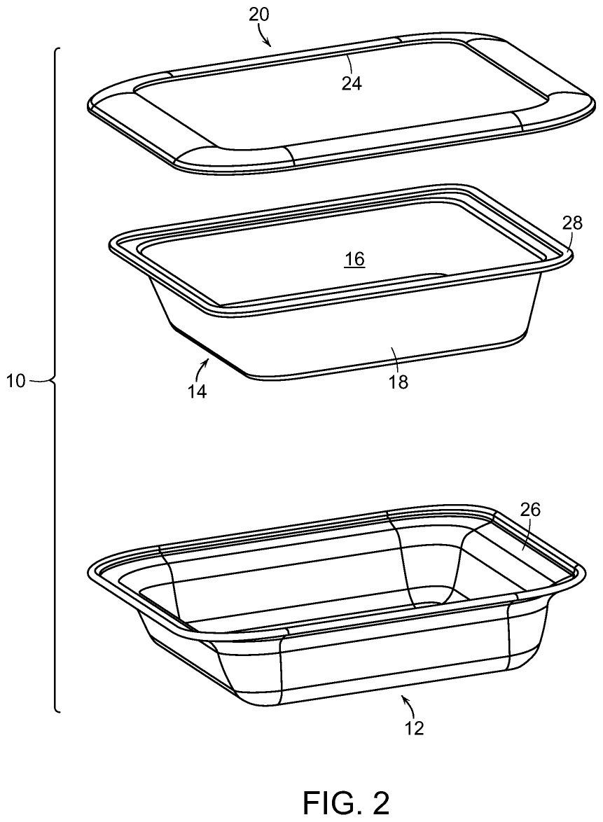

FIG. 2 is similar to FIG. 1 in that it shows an exploded view of the invention where the optional spacer block 30 is not utilized/required. As was the case with FIG. 1, in FIG. 2 there is a bottom holder/receptacle 12 which accommodates the tray 14 in its entirety. The bottom holder/receptacle 12 also has a lip 26 to help support the rim 28 of the tray 14. The lid 20 snaps into place and is fully removable.

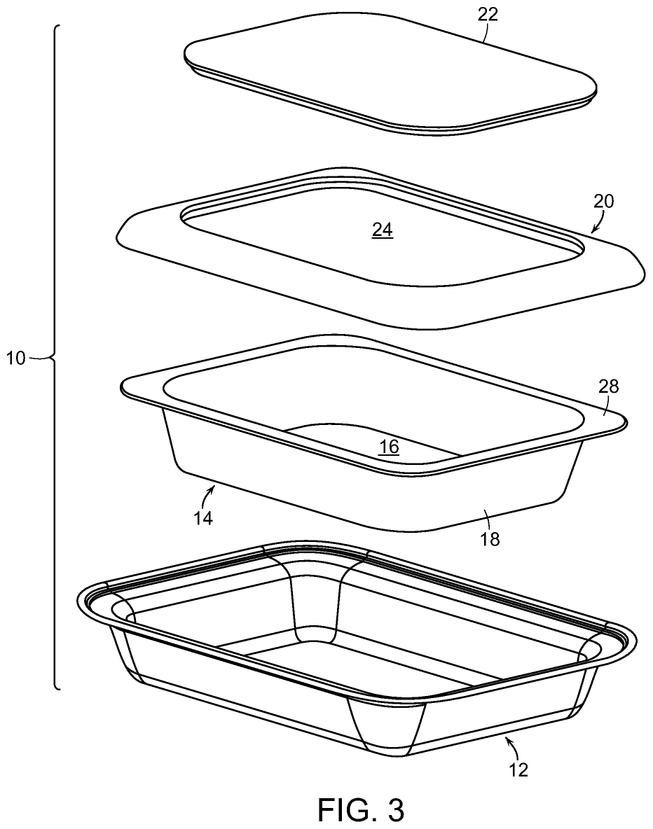

FIG. 3 is similar to FIG. 2 in that it shows an exploded view of a second preferred form of the invention. Here, the bottom holder/receptacle 12 is configured to receive the lid 20 over the lip 26 of the bottom holder/receptacle 12. The lid 20 includes an opening or aperture 24 which receives the cover 22 so that the decorative holder 10 may completely enclose the serving tray or tin 14.

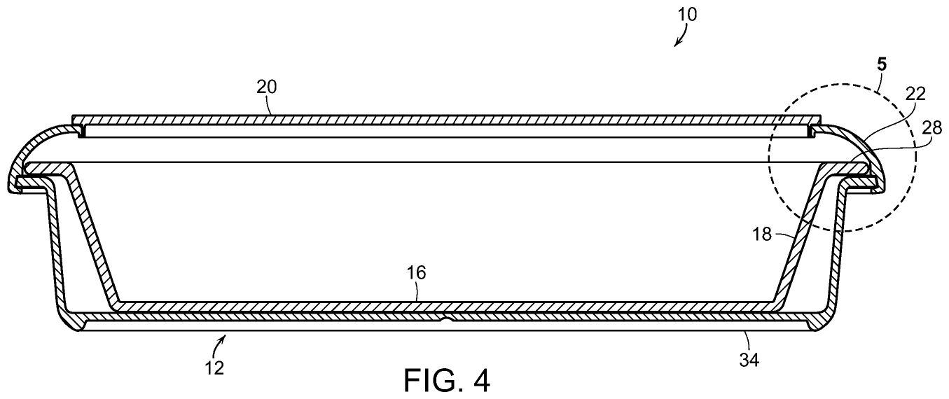

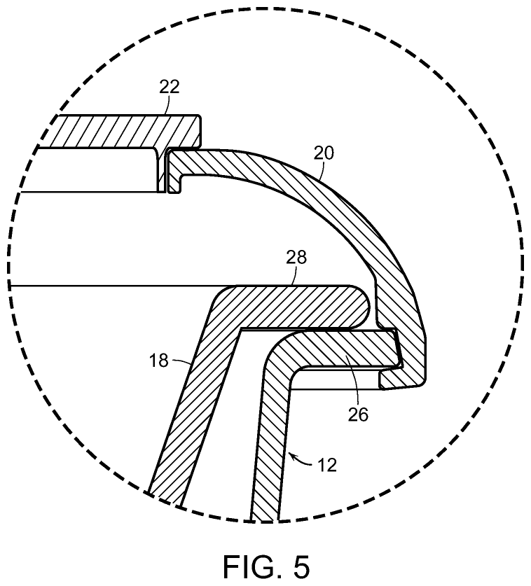

These features are further illustrated in FIGS. 4 and 5, wherein FIG. 4 is a sectional view through the assembled decorative holder of FIG. 3. FIG. 5 illustrates how the lid 20 is snap fit over the lip 26 of the bottom holder/receptacle 12, and also how the cover 22 is securely fitted over/within the aperture 24 defined by the lid 20.

FIGS. 6-8 illustrate a third embodiment of the invention wherein the lid 20 is pivotally attached to the bottom holder/receptacle 12 at a pair of hinges 32. This allows the lid 20 to be pivoted about the hinge 32 relative to the upper lip of the bottom holder/receptacle 12 for convenient insertion of serving trays or tins 14 within the bottom holder/receptacle 12 and then securely enclosing the serving tray or tin 14 beneath the closed lid 20. The lid 20 also includes a snap-fit latch on a side opposite the hinges 32 to provide a releasable catch for the lid 20 to the lip 26. In all other respects, the embodiment shown in FIGS. 6-8 is similar to the embodiment shown in FIGS. 3-5.

In all of the embodiments, it is preferred that the decorative holder 10 be provided with a non-skid bottom surface 34 and have a shape which facilitates the stacking and nesting of several decorative holders 10 one above the other. Of course, the shape of the particular decorative holder may vary as needed, including receptacles to accommodate loaf pans, circular containers, and even cupcakes.

Further, it should be understood that in addition to the spacer block 30 which may provide insulation to the bottom surface of the holder/receptacle 12, further insulation may be provided components of the decorative holder as needed so as to minimize heat transfer between a warmed serving tray/tin 14 and the outer walls of the decorative holder 10. Moreover, the lid 20 may have various configurations so as to accommodate the food contents within the serving tray or tin 14. For example, a lid 20 having an upward arch may be provided to accommodate food which extends upwardly from the serving tray or tin 14.

Although several embodiments of the invention have been described for purposes of illustration, various modification is may be made without departing from the spirit and scope of the invention. Accordingly, the invention is not to be limited, except as by the appended claims.

What is claimed is:

1. A decorative holder for foodstuff trays, tins, and pans, comprising:
a receptacle having a generally horizontal bottom wall and a contiguous upwardly extending wall;
a lid that is hingably coupled to the receptacle, the lid having a peripheral wall defining a central opening providing access to an interior region of the decorative holder when disposed atop the receptacle; and
a cover that is detachably coupled to the lid, the cover having a generally planar upper surface and a peripheral engaging wall that extends generally orthogonally from the upper surface;
wherein the receptacle and the lid are configured to hold and generally encapsulate a foodstuff tray, tin, or pan therebetween; and
wherein the peripheral wall of the lid and the peripheral engaging wall of the cover are generally parallel and configured to engage each other when the cover is coupled to the lid.

2. The decorative holder of claim 1, further comprising a spacer block provided between an interior surface of the bottom wall of the receptacle and a bottom surface of the food stuff tray, tin, or pan such that a layer of air comprising a majority of a surface area of the bottom wall of the receptacle is formed between the interior surface of the bottom wall of the receptacle and a bottom surface of the foodstuff tray, tin, or pan.

3. The decorative holder of claim 2, wherein the spacer block is removable.

4. The decorative holder of claim 1, wherein the receptacle further includes a non-skid bottom comprising a peripheral arc-shaped ridge extending from the bottom wall.

5. The decorative holder of claim 1, wherein the lid further comprises an exterior surface that slopes downwardly from an inner edge to an outer edge, and wherein the inner edge is the highest point of the exterior surface.

6. The decorative holder of claim 5, wherein the inner edge of the lid is positioned inwardly relative to the upwardly extending wall of the receptacle.

7. The decorative holder of claim 5, wherein at least a portion of the upper surface of the cover extends outwardly over the inner edge of the lid when the cover is coupled to the lid.

8. The decorative holder of claim 1, wherein the peripheral wall of the lid and the peripheral engaging wall of the cover are configured to connect together via snap fit engagement.

9. The decorative holder of claim 1, wherein the lid further comprises a snap-fit latch configured to provide a releasable catch for the lid to the receptacle.

10. A decorative holder for foodstuff trays, tins, and pans, comprising:
a receptacle having a generally horizontal bottom wall and a contiguous upwardly extending wall; and
a lid that is hingably coupled to the receptacle, the lid defining a central opening providing access to an interior region of the decorative holder when disposed atop the receptacle;
wherein the receptacle and the lid are configured to hold and generally encapsulate a foodstuff tray, tin, or pan therebetween; and
wherein the lid comprises an exterior surface that slopes downwardly from an inner edge to an outer edge, wherein the inner edge is the highest point of the exterior surface.

11. The decorative holder of claim 10, wherein the inner edge of the lid is positioned inwardly relative to the upwardly extending wall of the receptacle.

12. The decorative holder of claim 10, further comprising a spacer block provided between an interior surface of the bottom wall of the receptacle and a bottom surface of the food stuff tray, tin, or pan such that a layer of air comprising a majority of a surface area of the bottom wall of the receptacle is formed between the interior surface of the bottom wall of the receptacle and a bottom surface of the foodstuff tray, tin, or pan.

13. The decorative holder of claim 12, wherein the spacer block is removable.

14. The decorative holder of claim 10, wherein the receptacle further includes a non-skid bottom comprising a peripheral arc-shaped ridge extending from the bottom wall.

15. The decorative holder of claim 10, further comprising a cover that is detachably coupled to the lid.

16. The decorative holder of claim 15, wherein the cover comprises a generally planar upper surface and a peripheral engaging wall that extends generally orthogonally from the upper surface.

17. The decorative holder of claim 16, wherein the inner edge of the lid is configured to engage a region in which the upper surface intersects with the peripheral engaging wall of the cover when the cover is coupled to the lid.

18. The decorative holder of claim 17, wherein the inner edge of the lid is configured to connect together with the region in which the upper surface intersects with the peripheral engaging wall of the cover via snap fit engagement.

19. The decorative holder of claim 16, wherein at least a portion of the upper surface of the cover extends outwardly over the inner edge of the lid when the cover is coupled to the lid.

20. The decorative holder of claim 10, wherein the lid further comprises a snap-fit latch configured to provide a releasable catch for the lid to the receptacle.
